(19) United States
(12) Patent Application Publication
(10) Pub. No.: US 2004/0031864 A1
(43) Pub. Date: Feb. 19, 2004

(54) Granular material spreader capable of spreading a mixture of two or more dry materials

(76) Inventor: Gregory L. Johnston, St. Louis, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/223,972

(22) Filed: Aug. 19, 2002

(51) Int. Cl. A01C 3/06

(52) U.S. Cl. 239/653

(57) ABSTRACT

The present disclosure provides a granular material spreader composed of a granular material holding tank, a blower portion and a granular material output tube. The granular material holding tank is adapted to be carried on the back of a human operator. The granular material holding tank is divided into one or more reservoirs. The blower portion has an air output tube. The blower is adapted to be carried in the hand of the human operator. The granular material output tube is capable of receiving granular material from one or more of the reservoirs and introducing the granular material to an interior portion of the air output tube upstream from the end of the air output tube.

### CROSS-REFERENCE TO RELATED APPLICATIONS

None.

### STATEMENT REGARDING FEDERALLY SPONSORED RESEARCH

None.

### BACKGROUND OF THE INVENTION

1. Field of the Invention

The field of the invention relates generally to granular material spreaders. More specifically, the field of the invention relates to an air powered granular spreader capable of simultaneously spreading two or more different granular materials.

2. Description of Related Art

In the past, various systems have been proposed for spreading dry material, such as seed and fertilizer, onto the ground quickly and effortlessly. However, these systems either do not properly distribute seed across the ground or they are unduly complex and expensive.

For example, U.S. Pat. No. 5,503,090 to Guzan discloses a fertilizer spreader wherein fertilizer is contained in a tank that is strapped to the operator's back. Using gravity, fertilizer exits the tank through a hose and drops to the ground. Because the system uses no mechanical parts and relies solely on gravity, the device of Guzan does not quickly spread dry material across a large area.

Additionally, U.S. Pat. No. 5,429,305 to Munsey discloses an apparatus for simultaneously applying fertilizer to a conifer seedling and herbicide to an area around the conifer seedling. The system employs two tanks mounted to an operator's back and a shroud is placed over the conifer. Fertilizer is dispensed through a metered dispenser to the conifer within the shroud and fertilizer is pumped to the area outside the shroud. However, the device of Munsey is not helpful to spreading fertilizer across a large area.

Similarly, U.S. Pat. Nos. 6,5944,264, 3,603,482 and 5,339,994 disclose similar gravity or hand powered devices for spreading granular material. These devices each suffer from the inability to quickly spread the material over large areas.

Finally, U.S. Pat. No. 5,947,384 discloses a hand held yard blower that has been converted to distribute yard care material. The blower comprises a common handheld yard blower and that has a small container of yard card material attached to the blower output tube. A yard care material tube is attached to the blower output tube and end just past the end of the blower output tube. As a result, as yard care material trickles from the tube the blower spreads the material over a yard. However, the device is inadequate to spread large amounts of material across a yard as the blower output tube nor the operator could support the weight of a large amount of granular material for an extended period. Additionally, the device provides no method to stop flow of yard card material. Additionally, the device does not properly introduce material into the air stream of the blower. Because material is not properly introduced into the air stream of the blower, dry material is propelled in unexpected directions, partly due to deflection upon hitting the air stream and partly due to the material having a different component of velocity than the air stream. Finally, the device provides for only a single reservoir so that granular materials that should not be combined until spreading cannot be simultaneously spread, such as grass seed and fertilizer.

### BRIEF SUMMARY OF THE INVENTION

In one aspect the present invention provides a granular material spreader comprising a granular material holding tank, a blower portion, and a granular material output tube. The granular material holding tank is adapted to be carried on the back of a human operator. The granular material holding tank is divided into one or more reservoirs. The blower portion has an air output tube. The blower is adapted to be carried in the hand of the human operator. The granular material output tube is capable of receiving granular material from one or more of the reservoirs and introducing the granular material to an interior portion of the air output tube upstream from the end of the air output tube.

In a second aspect of the present invention there is provided a granular material spreader comprising a granular material holding tank, a blower portion and a reservoir granular material output tube attached to each of the reservoirs. The granular material holding tank is adapted to be carried on the back of a human operator and is divided into one or more reservoirs. The blower portion has an air output tube and is adapted to be carried in the hand of the human operator. Reservoir granular material output tubes are attached to each of the reservoirs and are capable of receiving granular material from its respective reservoir and introducing the granular material to an interior portion of the air output tube upstream from the end of the air output tube.

### BRIEF DESCRIPTION OF THE DRAWING

The FIGURE provides a perspective view of an embodiment of the present invention.

### DESCRIPTION OF THE PREFERRED EMBODIMENT

While the invention is susceptible of embodiment in many different forms, there is shown in the drawings and described in detail preferred embodiments of the invention. It is to be understood that the present disclosure is to be considered only as an example of the principles of the invention. This disclosure is not intended to limit the broad aspect of the invention to the illustrated embodiments. The scope of protection should only be limited by the accompanying claims.

The term “granular material” as used in the specification and claims is intended to cover all materials, including particulate, flowable powdery materials, or dust, which do not flow freely as a liquid but have factors of internal flow friction sufficient to stop flow from a supply source when flowing through a tube.

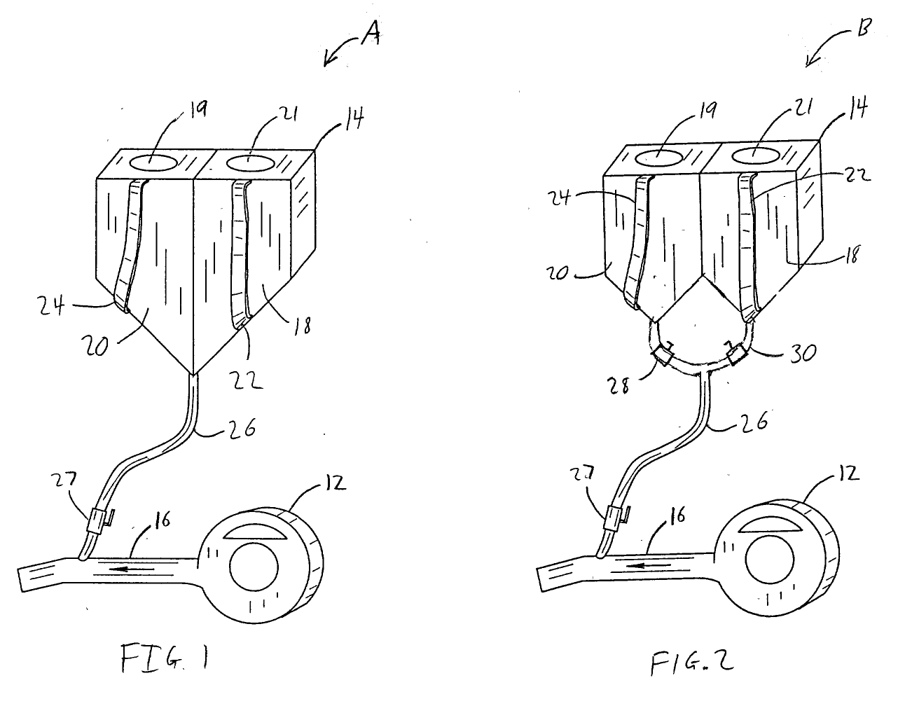

Referring to FIG. 1, there is shown a granular material spreader 10 according to the present invention. The granular material spreader generally comprises a handheld blower portion 12 and a backpack holding tank 14. The handheld blower portion 12 preferably comprises an electric motor attached to an impeller to generate airflow through an air output tube 16. Handheld are commonly known and readily available. While it is preferred that the handheld blower portion 12 is electric powered due to the light weight of electric motors, the handheld blower portion 12 may also be operated by a gas powered engine. It is further preferred that the blower of the present invention be a variable speed blower.

The backpack holding tank 14 preferably comprises a plastic tank that has been segmented into at least two separate holding reservoirs 18, 20. The backpack holding tank 14 also comprises two straps 22, 24 that are used to mount the backpack holding tank 14 to the operator of handheld blower portion 12. Attached to a bottom of the backpack holding tank 14 is a granular material output tube 26. The granular material output tube 26 is in flow communication with both reservoirs 18, 20 of the backpack holding tank 14, thereby allowing material in each tank to enter the granular material output tube 26.

Furthermore, the bottom of each reservoir 18, 20 is sloped toward the granular material output tube 26 to allow all of the material within each reservoir 18, 20 to enter by way of gravity into the granular material output tube 26. The top of each reservoir 18, 20 comprises openings 19, 21 whereby granular material may be added to each reservoir 18, 20. Also provided is a granular material output tube 26 flow control valve 27, which is preferably comprises a ball valve, for infinitely controlling the flow of material from the backpack holding tank 14.

In FIG. 2, there is a shown a second embodiment of the present invention. The second embodiment differs from the first embodiment in that each reservoir 18, 20 of the backpack holding tank 14 has its own reservoir granular material output tubes 28, 30 that feed into the granular material output tube 26. The bottom of each reservoir is sloped such that the reservoir granular material output tubes 28, 30 are attached at the lowest point of each reservoir 18, 20. Also, valves 28, 30 may be provided to control the flow of the granular material from each reservoir 18, 20. Because valves 28, 30 are provided, the valve 27 may optionally be omitted. While valves 28, 30 are shown in FIG. 2, one of ordinary skill in the art can easily appreciate that they are not necessary to implement the present invention and can be omitted.

In use, the blower spreader of the present invention is operated by turning on the blower portion 12 and opening the desired valves 27, 28, 30 (if equipped with all valves) in the desired amounts and proportions. The user than directs the blower to the area where the granular material is to be spread. The user can adjust the blower motor speed in order to provide less or more force to the granular material to spread it to a near or far-away area. The major advantages of the present invention is the ability to carry large amounts of granular material on the back of the operators, the ability to separate different types of granular material until the material is spread and the ability to introduce the granular material to the air stream while still in the tube in order to expel the granular material from the tube in a consistent and predictable manner.

While the specific embodiments have been illustrated and described, numerous modifications come to mind without significantly departing from the spirit of the invention, and the scope of protection is only limited by the scope of the accompanying claims.

I claim:

1. A granular material spreader comprising:
a granular material holding tank adapted to be carried on the back of a human operator wherein the granular material holding tank is divided into one or more reservoirs;
a blower portion having an air output tube wherein the blower is adapted to be carried in the hand of the human operator;
a granular material output tube capable of receiving granular material from one or more of the reservoirs and introducing the granular material to an interior portion of the air output tube upstream from the end of the air output tube.

2. The spreader of claim 1 further comprising two reservoir granular material output tubes that feed material into the granular material output tube.

3. The spreader of claim 2 wherein each of the two reservoir granular material output tubes further comprise a valve.

4. The spreader of claim 1 wherein the granular material output tube further comprises a valve.

5. The spreader of claim 1 wherein the blower portion comprises an electric motor.

6. The spreader of claim 1 wherein the blower portion comprises a gasoline engine.

7. A granular material spreader comprising:
a granular material holding tank adapted to be carried on the back of a human operator wherein the granular material holding tank is divided into one or more reservoirs;
a blower portion having an air output tube wherein the blower is adapted to be carried in the hand of the human operator;
a reservoir granular material output tube attached to each of the reservoirs and capable of receiving granular material from its respective reservoir and introducing the granular material to an interior portion of the air output tube upstream from the end of the air output tube.

8. The spreader of claim 7 wherein the reservoir granular material output tubes each combine to provide granular material from its associated reservoir to a granular material output tube that is further attached to the air output tube.

9. The spreader of claim 8 wherein the granular material output tube further comprises a valve.

10. The spreader of claim 8 wherein the blower portion comprises an electric motor.

11. The spreader of claim 8 wherein the blower portion comprises a gasoline engine.

12. The spreader of claim 8 wherein each of the reservoir granular material output tubes further comprise a valve.

13. The spreader of claim 7 wherein each reservoir granular material output tube is further directly attached to the air output tube.

14. The spreader of claim 13 wherein each of the reservoir granular material output tubes further comprise a valve.

15. The spreader of claim 13 wherein the blower portion comprises an electric motor.

16. The spreader of claim 14 wherein the blower portion comprises a gasoline engine.
